(19) United States
(12) Patent Application Publication
(10) Pub. No.: US 2010/0148475 A1
(43) Pub. Date: Jun. 17, 2010

(54) MODULAR TRAILER WITH EXPENDABLE CHASSIS

(76) Inventor: René Serre, Saint Georges d'Orques (FR)

Correspondence Address: Rene' Serre, 5 Rue de l'aramon, Saint Georges D'Orques, 34680, FR

(21) Appl. No.: 12/450,291

(22) PCT Filed: Mar. 17, 2008
(86) PCT No.: PCT/FR2008/000357

§ 371 Date: Sep. 14, 2009

(30) Foreign Application Priority Data
Mar. 23, 2007 (FR) 0702148

(51) Int. Cl. B62D 21/20

(52) U.S. Cl. 280/656

(57) ABSTRACT

Modular trailer for motor vehicles, with frame stretched length and width, doubling its floor space without changing the front angle of the coupling tongue (9).

The frame consists of four channel side rails of identical length (1) and (2), two to two coupled, for carrying the extensions that slide in, one on one side (front) (3) the other on the opposite side (back) (4) and five cross members (5) on which nest and slide on both sides the 2 additional extension members (6) to allow so the width variation of the chassis. The change of the axle works is made on the same way. (7) and (8). The coupling tongue receives an extension on each arm.

It allows the transport of raw materials (when it is folded), or large but light material (eg insulation wall plates . . . ) In the deployed versions deployed, it allows transporting a motorcycle or a boat if the chassis receives the appropriate accessories; its look is completely changed if the frame receives a composite body.

### TECHNICAL FIELD

This invention is a lightweight adjustable trailer for motor cars, built on a framework that can be swivelled, extendable in length and width so as to double its floor spate without changing the angle in the front of the coupling tongue (triangle)

### BACKGROUND OF THE INVENTION

Light trailers are traditionally an economic supplement to all categories of motor vehicles because they can increase their transport capacity at low cost. However none of them provides enough flexibility to accommodate a maximum of practice: removals, DIY, various leisure activities (transport motorcycles, jet skis, garden tools . . . ).

Existing solutions of modular frameworks either are not directly trailers for cars, or they are based on different devices; for instance FR 2 474989 (extension does not fit on the main framework and the framework does not tilt; this framework seems intended primarily for factory constructed trailers of different sizes on the same chassis avoiding welding during assembly (once, definitive) produced at the factory). The end user does not have the opportunity to adapt his own framework in terms of its immediate use.

None of the solutions allows such expansion going up to double the floor space,

They relate only to the chassis while the present invention proposes a variation of the dimensions of the chassis and the bodywork,

They do not mention the possibility for swivelling the chassis.

### DISCLOSURE OF THE INVENTION

This invention is a modular trailer with an expandable framework, in length and width, designed to enable its users to adapt itself according to its immediate needs. Therefore the technical design should not be based on complex processes and seek long ways to implement.

In response to a multitude of uses, this trailer chassis, by design, can:
be fitted with accessories that increase the transport of goods, objects and materials safely.
receive a cell of composite material that totally change the appearance of the trailer.

Its chassis (made of galvanized square tubes for this device) is characterized by two channel side rails on both sides, (right and left) On each side, the two tubes are welded in pairs (four members of identical length), and so receive the pair of longitudinally extending members that enters into it, one on the front side in one of the welded tubes, the other on the back side in the other tube. This telescoping framework allows also an extension in the length

Five cross-bars on each two telescoping extensions slide on both sides of the cross-members allow the variation in width of the chassis if the extensions are deployed. Each of these extensions are attached to the two welded square tubes that have been described above under the first characteristic. Depending on the chosen device the cross-bars (and associated extensions) on the front and the one that receives the fixing of the coupling triangle are larger than all the other cross-bars and associated extensions).

Between the folded position and the maximum extended position, one or more intermediate positions of the chassis can be considered, which allows the fixing of accessories such as a bike ramp (usual standard length 2 m).

According to the characteristics of the axle chosen, it is necessary to provide a device for varying the gauge. In the context of present device, the axle (mounted on leaf springs), consists of a cylindrical tube cut through the middle, each of these two parts being nested on a pipe (with a smaller dimension) to slide. Bolts with nuts through all the tubes maintain the selected position.

Doubling the size of the deck (galvanized iron) is made possible on one hand by unscrewing the frame and rotating (the length in the folded position becomes the width in the deployed position) on the other hand by adding a second sheet with the same area, if this sheet is considered as an accessory, or by splitting the initial deck to form the deck in the folded position, if the option of two overlapping sheets is selected

The coupling system (coupling tongue) consists of a triangle whose front angle does not vary, whatever the position is (folded or deployed), which allows for mounting a fixed coupling hook. This is made possible because of the variation in the length of the coupling triangle by adding an extension which nest in (after disassembly) in each arm of the hitch tongue and a lateral move of the two attachment points of the coupling tongue on the cross-bar (on which it is attached) according to the position commanded by the change in the length of the coupling tongue (expansion-reduction of a triangle).

Using a system of articulation between the coupling triangle and the cross-bar where it's fixed and a locking system on front cross, allows a swivel body.

### BRIEF DESCRIPTION OF DRAWINGS

Six drawing sheets illustrate the invention:

FIG. 1 is a simplified layout of the frame in its folded position
This figure represents:
The chassis with two stringers (1) and (2), right side and left side (four side rails of identical length, welded in pair for carrying extensions (3) and (4) they nest in each other (telescoped), one on one side (front) (3) the other on the opposite side (rear) (4).
The five lateral cross-members (5) on each side of which the sliding extensions nest in it (6) to change the width of the chassis when the extensions are deployed. Each one of these extensions is attached, on one of their end, to the longitudinal side rails as described above under the first characteristic. Depending on the shape of the implementation chosen, the front cross member (and associated extensions) and the one receiving the fixing of the coupling tongue are larger than the others (with those associated extensions).
The axle (7) that consists of a cylindrical tube, cut through the middle, each of these two parts being nested on a pipe section just below (8) to slide in it. Bolts with nuts through all the tubes ensure the maintenance of each selected position.
The coupling tongue (9) whose angle in front does not vary, whatever the position (folded or deployed).

FIG. 2 is a simplified layout of the framework position that represents the same elements as in FIG. 1, beyond the extension (10) which nests in each arm of the coupling tongue.

FIG. 3 is a simplified view of the rear of the trailer in the folded position with over the two half extensions of the cross member (6), on which are attached the two half ramps with the traffic lights, and the rear panel that consists of two layered profiles (11) and (12) which slide against one another on more than 2 thirds of their length. These sections are surrounded by a metal “U” (13). This framework of the rear panel is cut in the middle of its length (to allow the expansion by sliding sections one on the other) and supporting a tube “U” (14) with just higher dimensions.

The ramp supporting the traffic lights and the registration plate is cut in the middle of its length: a half left ramp (15) and half right ramp (16).

FIG. 4 represents the rear of the trailer in deployed position in a simplified way, incorporates the above described elements, in addition to the extension (5) of the rear cross member, visible in the middle.

FIG. 5 is a simplified lateral view of the trailer side, in the unexpanded position, specially the side panel (17) constituting the length and made of a galvanized threaded profile, surrounded by a metal framework consisting of a “U” tube” (18). Each side of this frame nests on the front and rear ends of the frame of the trailer in planned square holes.

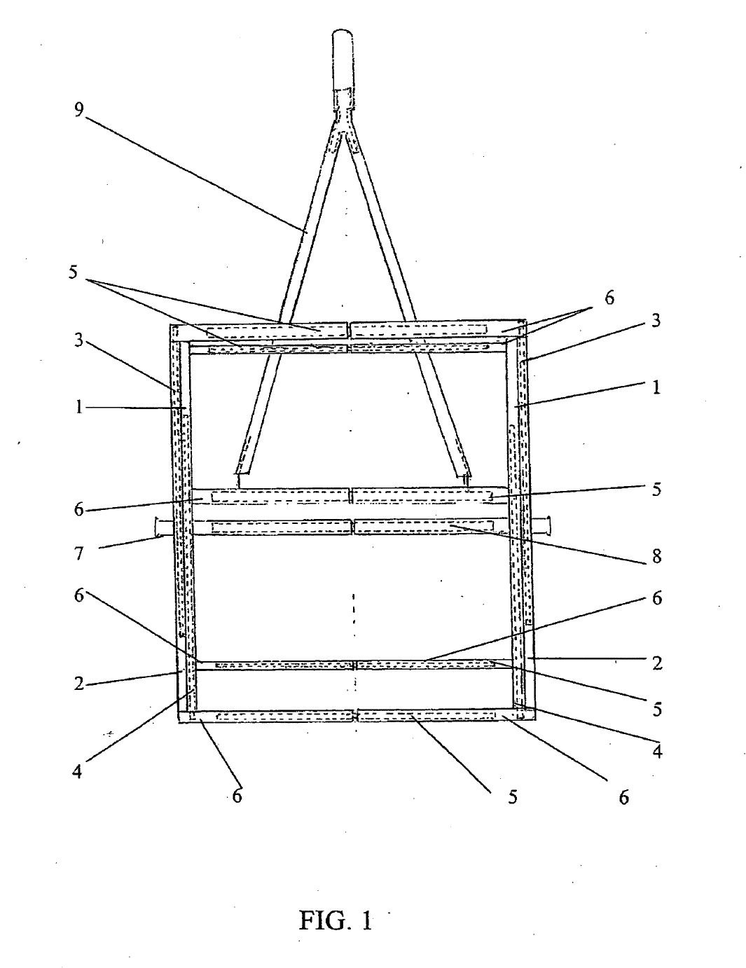

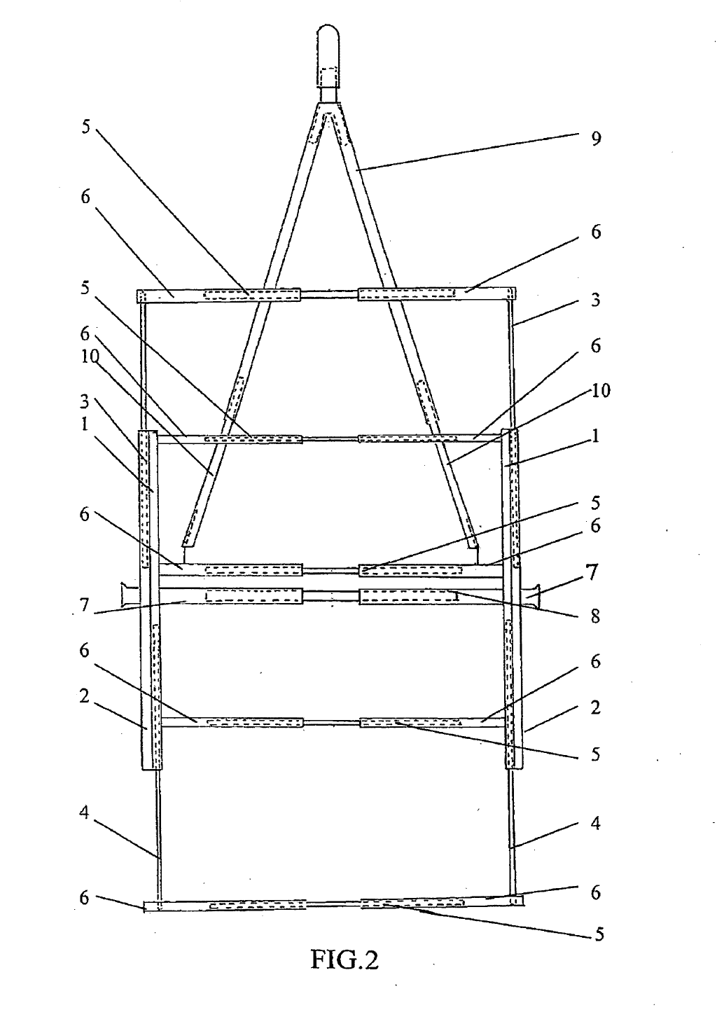

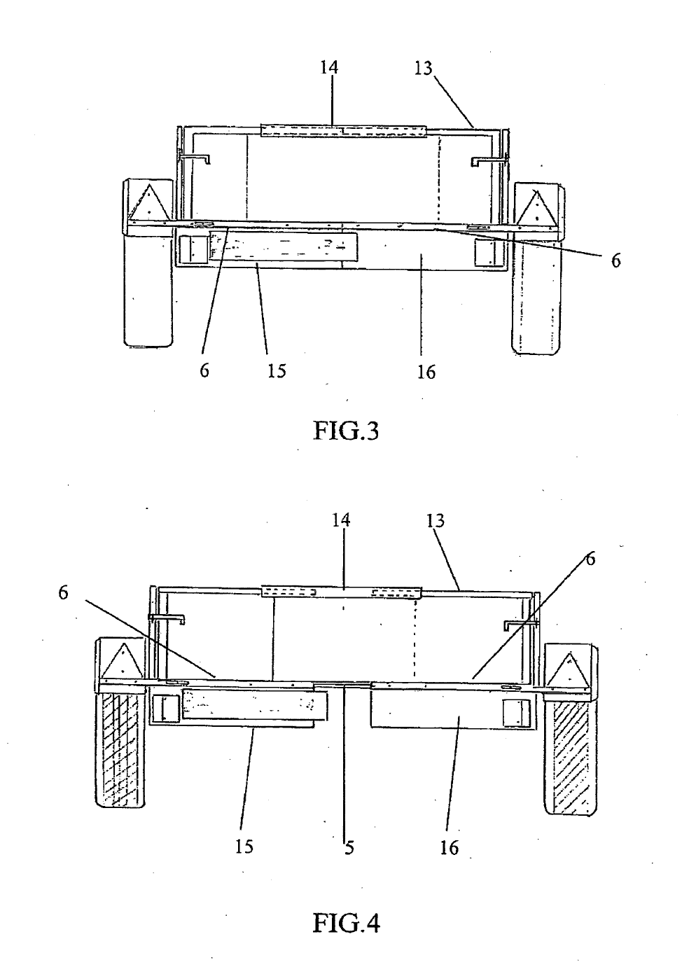

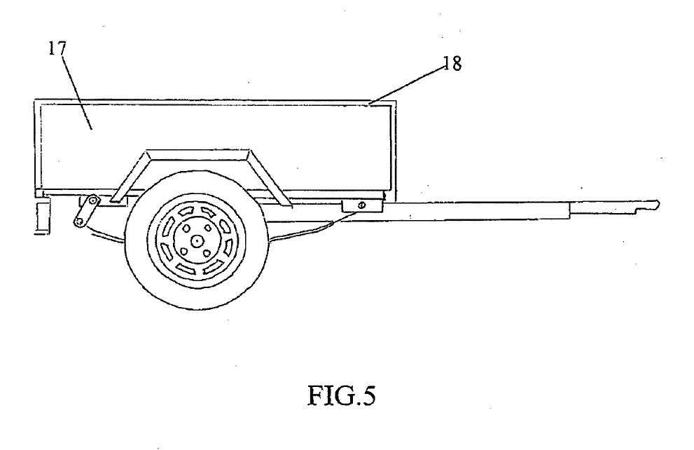

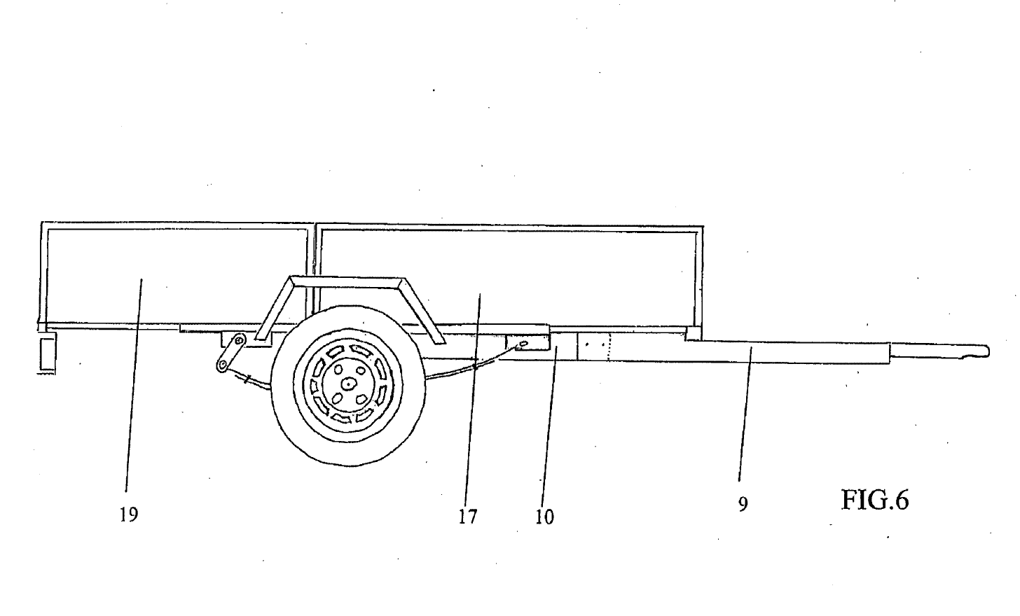

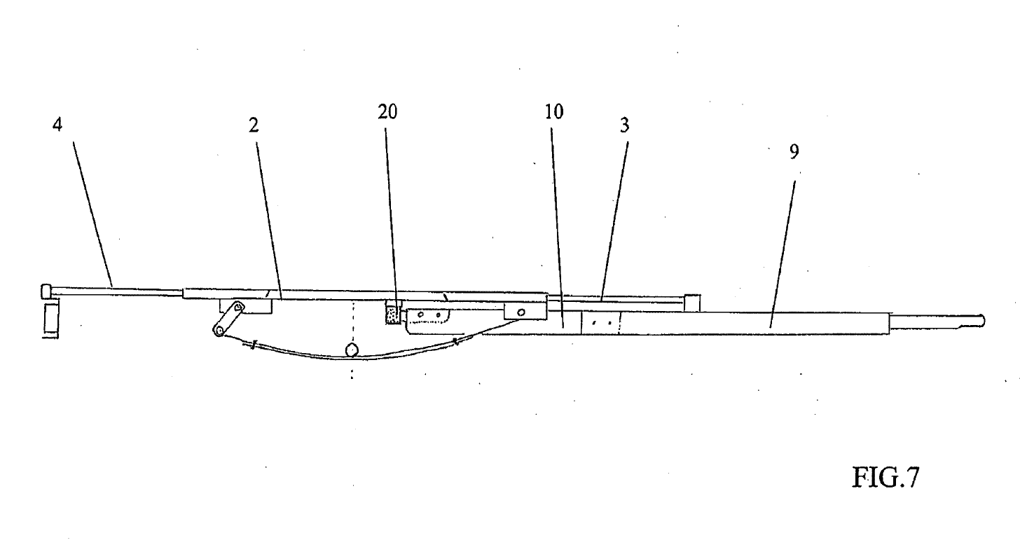

FIG. 6 represents a simplified lateral view of the trailer in the extended position, and specially:
The side panel (17) who is the length in the contracted position,
The extension side panel (19),
The coupling tongue (9) with its extension (10),

FIG. 7 is a simplified lateral view of the bare framework in the extended position, which shows:
The lateral side of the two in pairs welded tubes (2), in which enters the telescoping front (3) and rear (4) extensions.
The coupling tongue (9) and its extension (10),
The coupling tongue fastener on one of the cross members of the chassis, with a mechanism that allows the tilting of the body (20).

### HOW TO CARRY OUT THE INVENTION

In the context of present device, the side panels are galvanized profiles surrounded on the top, the bottom and the sides with a metal frame made of an “U” tube. The front and rear side panels (representing the width) are composed of two overlapping parts which slide against each other on more than 2 thirds of their length

They are, in the same way enclosed in metal “U” tube (see the above description of the longitudinally side panels). Those frames are furthermore cut in the middle of their length (to allow the expansion by sliding the profiles one on the other) and a “U” tube with a just higher dimension is nest on the cut on the top. To adapt each side panel to the width of the frame, the maintaining tube previously described is removed, then the profiles are extend for a greater length. Once you get the right size, the maintaining “U” tube U is put back on the frame

The front and rear side panels are fixed to the frame using hinges, which can be easily removed and then lowered for easier loading.

In the context of present device, in the folded position, the length side panels are on galvanized profiles that are surrounded on the upper part and both sides in a metal frame whose profile is shaped like a “U”)

The sides of the frame nest on the front and rear ends of the frame in square holes provided. In deployed position according to this version, each side panel is extended by an additional side panel built using the same rules. This additional side panel nests into the chassis on one of its side, the other is fixed with bolts and nuts to the chassis and the side panel of the folded position, which remains in place.

### POSSIBILITIES FOR INDUSTRIAL APPLICATIONS OR USE

The trailer is intended mainly to individuals: in its short version, it allows to carry raw or compact materials and in its deployed position, light but bulky material (sofa, wall insulation plates . . . ).

With accessories, the framework of the trailer can also be used for carrying a motorcycle or two of them, a jet ski, quad, boat or small boat fishing.

The frame associated with a cell of composite material, completely changes the appearance of the trailer while responding to a request for users wanting to move away from traditional forms of trailers. Use of this cell type also offers original storage capacity if it includes cells equipped with closures which allows for recreational use (vacations or other leisure activities).

Other accessories (like a frame for carrying glasses) can adapt the chassis to a light professional use.

What is claimed is:

1) Device that is a lightweight adjustable trailer for motor car built on a framework that can be swivelled extendable in length and width, without changing the front angle of the coupling tongue, and characterized by 4 channel side rails (coupled in pairs) and forming the length of the frame on the left and right sides of the frame.

2) Device as claimed in claim 1 that is characterized by four rails that are sliding extensions and nest inside the rails of claim 1, on one side (front) and the other by the other side (back) and slide in it. (telescoping system)

3) Device as claimed in claim 1 representing the width of the chassis and allowing its extension in width, characterized by five constituent square tubes that are the cross members on which slide twin tubes with an upper section on both sides. Each of these tubes is attached at one of its ends to the coupled rails mentioned in claim 1 above.

4) Device according to any of the claims above characterized by its front cross member (and associated extensions) and the cross member (and its associated extensions) receiving the fixing of the coupling tongue are larger than those backward and inward and their extensions.

5) Device according to any of the claims above, characterized in that between the folded position and maximum stretched position, one or more intermediate positions of the frame are possible.

6) Device according to any of the claim above characterized in that some bolts with nuts in sufficient number, passing through the chassis and extension, maintain the chosen length and width.

7) Device according to any of the claims above, characterized in that the axle is made of a cylindrical tube cut through the middle, each of these two parts are nested through a tube that has a smaller diameter to allow to slide in it; bolts with nuts holding the chosen gap.

8) Device according to any of the claims above characterized by the doubling of floor space due to the juxtaposition of two plates of identical dimensions, each having an area for covering the frame and forms the bottom of the box when the trailer is in the folded position; the length in the folded position becomes the width in the extended position and length in the extended position consisting of the sum of the widths of sheets disposed one beside the other.

9) Device according to any of the claims above characterized by a boom coupling triangle whose apex angle does not vary because of variation in the length of the coupling triangle by adding an extension to it threads on each side of longitudinal, and lateral displacement of the two attachment points of the coupling triangle on the cross on which it is fixed.

10) The device of claim 9 above, characterized by an articulation system of the coupling tongue on the cross member and a lock on the front cross member and the coupling tongue.

11) Device according to any of the claims above characterized in that the sidewalls of the trailer constituting the width of the body (front and rear) are two overlapping galvanized sheet sections, sliding against each other on more than 2 thirds of their length, surrounded by a metal frame in a “U” cutting in its middle on both lengths, the whole system constituting so the front and rear side walls that are fixed to the frame by means of hinges and surrounded by an “U” tube.

12) Device according to any of the claims above characterized in that the ramp supporting the traffic lights and the registration plate is cut in the middle of its length: left half ramp and right half ramp.

13) Device according to any of the claims above characterized in that the sidewalls of the trailer (racks) constituting the length of the body are galvanized sheet sections, surrounded on the top and sides of a metal frame that consists of a “U” tube that nests on the front and rear ends of the chassis in the square holes provided for this purpose.

14) Device according to any of claims above that in its deployed position, has each side panel forming the length of the body extended by an additional side panel built following the same rules and nests into the frame on one its side, the other being fixed by bolts to the chassis and the side rail of claim 12 remained in place.
